(19) United States
(12) Patent Application Publication
(10) Pub. No.: US 2010/0171844 A1
(43) Pub. Date: Jul. 8, 2010

(54) IMAGING APPARATUS

(75) Inventors: AKIHIRO OKAMOTO, Osaka (JP); AKIRA OHASHI, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/683,472

(22) Filed: Jan. 7, 2010

(30) Foreign Application Priority Data
Jan. 8, 2009 (JP) 2009-002300

(51) Int. Cl. H04N 5/235

(52) U.S. Cl. 348/229.1; 348/E05.037

(57) ABSTRACT

An imaging apparatus includes an imaging unit operable to output an image signal of a subject, an amplifier unit operable to amplify the image signal output by the imaging unit, a gain adjusting unit operable to adjust a gain of the amplifier unit, and a frame rate adjusting unit operable to set a read frame rate of the imaging unit for a normal operation period to a first frame rate, and set the read frame rate for a focus operation period to a second frame rate which is larger than the first frame rate. When the frame rate adjusting unit changes the read frame rate of the imaging unit from the first frame rate to the second frame rate, the gain adjusting unit adjusts the gain of the amplifier unit so that a substantially equivalent exposure amount is maintained before and after the change in the read frame rate.

### BACKGROUND

1. Technical Field

The technical field relates to an imaging apparatus capable of an automatic focus operation.

2. Related Art

In recent years, a digital camera has been very widely used. A compact digital camera for beginners in photo is desirably operable by any user without regard to his/her skill to take a picture of a predetermined quality. For this purpose, a focus operation is normally performed automatically, and in order not to lose the right timing for taking a good picture, a focus operation period is required to be as short as possible.

Many compact digital cameras have no optical viewfinder. With such digital cameras, the user continues to watch a subject through a liquid crystal device monitor provided on the rear surface of the digital camera during the focus operation period. Therefore, during the focus operation period, the image of the subject is required to be displayed free of the sense of incongruence on a display unit.

Generally, the autofocus operation is divided into an active type and a passive type. The autofocus operation of active type emits infrared light or ultrasonic wave to the subject to measure the distance to the subject based on the reflection signal, and it is often employed for a compact silver film camera.

On the other hand, the autofocus operation of passive type measures the distance based on an image captured by an optical system, and the method thereof is further divided into a phase difference detection method and a contrast detection method. The phase difference detection method is employed in many single-lens reflection cameras regardless of silver film type or digital type. On the other hand, many compact digital cameras employ the contrast detection method.

According to the contrast detection method, while the focus lens in the optical system is moved gradually, and the position of the focus lens at which the contrast of the captured image reaches a local maximum value is determined as a focus position. The contrast is generally evaluated based on the high-frequency component of the captured image.

Evaluation of the high-frequency component is performed on a frame-by-frame basis, and thus in order to shorten the focus operation period the read frame rate of the imaging device is required to be increased. However an increased read frame rate of the imaging device decreases the exposure time. As a result, the brightness of the display unit is decreased, and the autofocus operation according to the contrast detection method becomes unstable on the other hand.

A digital camera intended to solve the aforementioned problem is proposed by JP-A-2003-262788. In the digital camera described in JP-A-2003-262788, the read frame rate of the imaging device is increased in the case where the brightness of the subject is not less than a first threshold value, and is decreased in the case where the brightness of the subject is not more than a second threshold value. By doing so, a high-speed focus operation is performed with a high read frame rate in the case where the brightness of the subject is high, while a long exposure time can be secured by a low read frame rate in the case where the brightness of the subject is low.

However, the digital camera described in JP-A-2003-262788 has the problem that the low read frame rate for a dark subject makes a high-speed focus operation impossible.

### SUMMARY

The present invention has been devised to solve the above problem, and an object thereof is to provide an imaging apparatus capable of a high-speed focus operation even for a dark subject.

In a first aspect, an imaging apparatus includes an imaging unit operable to output an image signal of a subject, an amplifier unit operable to amplify the image signal output by the imaging unit, a gain adjusting unit operable to adjust a gain of the amplifier unit, and a frame rate adjusting unit operable to set a read frame rate of the imaging unit for a normal operation period to a first frame rate, and set the read frame rate for a focus operation period to a second frame rate which is larger than the first frame rate. When the frame rate adjusting unit changes the read frame rate of the imaging unit from the first frame rate to the second frame rate, the gain adjusting unit adjusts the gain of the amplifier unit so that the substantially equivalent exposure amount is maintained before and after the change in the read frame rate. As described above, the shortage of the exposure time due to the increased read frame rate is offset by increasing the gain of the image signal, and therefore, a high-speed focus operation is made possible. Also, since the image displayed on the display unit is not darkened, the display quality of the display unit can be maintained.

In addition, the gain adjusting unit may adjust the gain of the amplifier unit in accordance with a brightness of the subject. As a result, the gain is increased only for a dark subject, and therefore the problem of the S/N deterioration which might be caused by increase of gain more than necessary is avoided.

According to the imaging apparatus of the aforementioned aspect, the shortage of the exposure time caused by the high read frame rate is compensated by increasing the gain of the image signal. Hence, the image signal of a predetermined level can be secured even if a read frame rate becomes high, and the image data can be evaluated accurately at the detection of the focus position, enabling a high-speed focus operation.

### BRIEF DESCRIPTION OF DRAWINGS

FIG. 1 is a block diagram showing a digital camera according to an embodiment of the present invention.

FIG. 2 is a flowchart showing an example of the process of a focus operation performed in a contrast detection method.

FIG. 3 is a waveform diagram showing the concept of a gain adjustment.

FIG. 4 is a timing chart showing the transition from a normal operation period to a focus operation period.

FIG. 5 is a timing chart showing the transition from the focus operation period to the normal operation period.

FIG. 6 is a diagram for describing the gain switching.

### DETAILED DESCRIPTION OF PREFERRED EMBODIMENTS

An imaging apparatus according to an embodiment of the present invention is described below with reference to the accompanying drawings.

### 1. Configuration

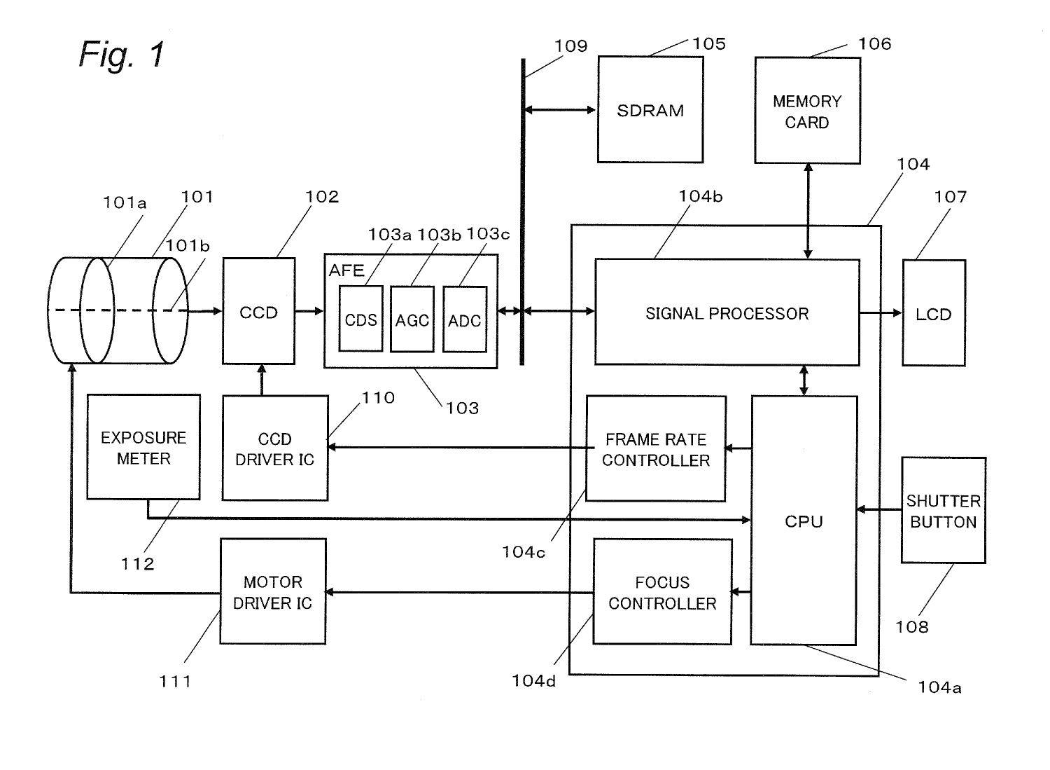

FIG. 1 is a block diagram of a digital camera which is one embodiment of an imaging apparatus. An optical system 101 focuses the image of a subject on a CCD 102. The optical system 101 is composed of plural lenses (not shown) including a focus lens 101a. The focus lens 101a moves along an optical axis 101b in a lens barrel holding the lenses thereby to focus the image of the subject on the CCD 102.

The CCD 102 outputs an image signal of the subject thus focused. An AFE (Analog Front End) 103 converts an analog image signal output from the CCD 102 to a digital image signal as an image data, and stores it in a SDRAM 105 through a bus 109. The AFE 103 is an LSI including a CDS (Correlated Double Sampling) circuit 103a for removing noise components of the image signal, an AGC (Automatic Gain Control) amplifier 103b for adjusting the magnitude of the image signal, and an A/D converter 103c for converting an analog signal to a digital signal.

A signal processing LSI 104 includes a CPU 104a, a signal processor 104b, a frame rate controller 104c and a focus controller 104d. The CPU 104a controls the whole operation of the signal processing LSI 104 in accordance with the instruction recorded in a ROM (not shown) included in the signal processing LSI 104. The signal processor 104b converts the image data stored in the SDRAM 105 with the AFE 103 to a display data suitable for display on the LCD 107, and outputs display data to the LCD 107.

The CPU 104a sends a command for requesting the AFE 103 to set the level of the gain of an AGC amplifier 103b. The signal line for sending the command from the CPU 104a to the AFE 103 is not shown in FIG. 1.

The focus operation period is started by half-pressing a shutter button 108, and the imaging operation performed by full-pressing the shutter button. In the case where the image data stored in the SDRAM 105 is the one captured by full-pressing the shutter button 108, the signal processor 104b converts the image data to a record data and stores it in a memory card 106. The data recorded in the memory card 106 is converted to a display data by the signal processor 104b and is displayed on the LCD 107.

When the focus operation period is started by half-pressing the shutter button 108, the signal processor 104b determines the intensity of the high-frequency component of the image data stored in the SDRAM 105. The high-frequency component of the image data can be obtained by converting the image data to the spatial frequency data by the Fourier transform, the discrete cosine transform, the wavelet transform, or the like.

The focus controller 104d sends a drive signal to a motor drive IC 111 to move the focus lens 101a by a minute distance toward the infinity side or the near limit side. Again, the signal processor 104b determines the intensity of the high-frequency component of the image data stored in the SDRAM 105. By repeating the aforementioned operation, the focus lens 101a is moved to a focus position at which intensity of the high-frequency component of the image data is a local maximum. During the focus operation period, the signal processor 104b converts the image data stored by the AFE 103 in the SDRAM 105 into the display data suitable for display on the LCD 107 to display it on the LCD 107. Hence, the user can view the subject through the LCD 107 even during the focus operation period.

The frame rate controller 104c has the function of changing the read frame rate of the CCD 102. An exposure meter 112 detects the brightness of the subject and notifies it to the CPU 104a. The CPU 104a sends a command for requesting the frame rate controller 104c to determine the degree to which read frame rate of the CCD 102 is set. The frame rate controller 104c sends a drive signal to the CCD drive IC 110 to change the read frame rate of the CCD 102.

The CCD 102 is an example of an imaging unit, and the AGC amplifier 103b in the AFE 103 is an example of an amplifier unit. Also, the frame rate controller 104c and the CCD drive IC 110 are examples of a frame rate adjusting unit. Further, the CPU 104a is an example of a gain adjusting unit.

In the digital camera according to the embodiment, the brightness of the subject is detected by the exposure meter 112. Nevertheless, the brightness detection method is not limited to this example. As an alternative, the signal processor 104b may detect the brightness of the subject based on the brightness component contained in the image data. Also, the AGC amplifier 103b in the AFE 103 may be included in the MOS imaging device such as the CMOS image sensor.

The AFE 103 and the signal processing LSI 104 may be integrated into a single LSI. The frame rate controller 104c may be included in the signal processor 104b, and the function of the frame rate controller 104c may be realized by the CPU 104a.

### 2. Operation

### 2.1 Focus Operation

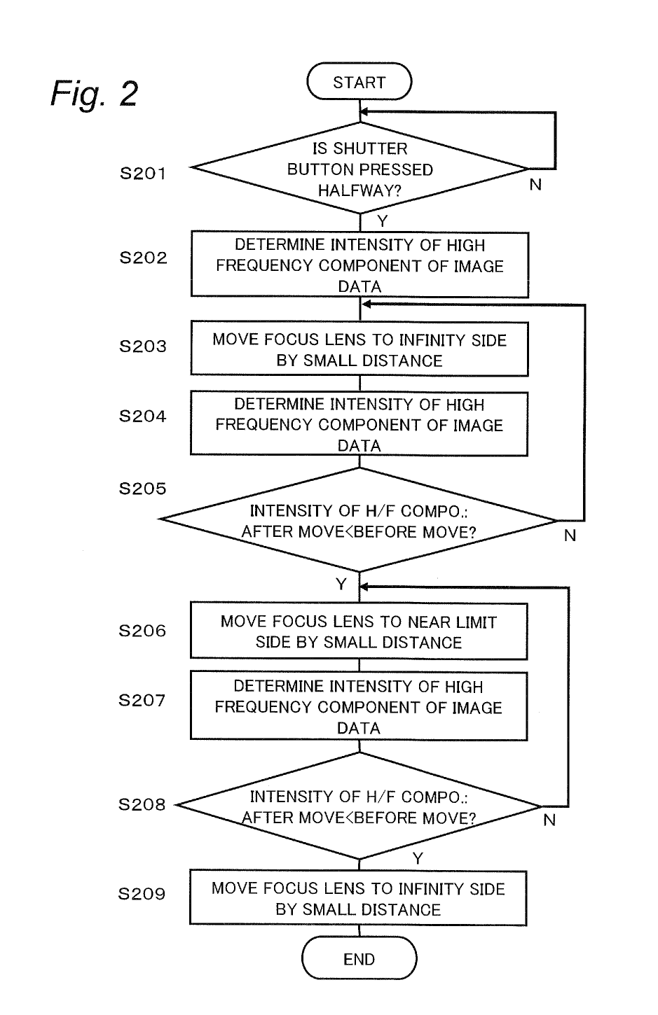

FIG. 2 is a flowchart showing an example of the process of the focus operation in the contrast detection method. With reference to FIG. 2, the focus operation of the digital camera according to the embodiment is explained.

The focus operation is started by half-pressing the shutter button 108 (Y in S201). Even during the focus operation period, the CCD 102 outputs the image signal based on the read frame rate, and the AFE 103 stores (updates) the image data in the SDRAM 105.

The intensity of the high-frequency component of the present image data is determined (S202). The focus lens 101a is moved by a minute distance to the infinity side (S203) and the intensity of the high-frequency component of the image data is determined again (S204). In the case where the intensity after moving the focus lens 101a is larger than that before moving the same (NO in S205), the steps S203 and 5204 are repeated.

In the case where the intensity after moving the focus lens 101a is smaller than that before moving the focus lens 101a (YES in S205), on the other hand, the focus lens 101a is moved to the near limit side by a minute distance (S206), and the intensity of the high-frequency component of the image data is determined again (S207). In the case where the intensity after moving the focus lens 101a is larger than before moving the focus lens 101a (NO in S208), the steps S206 and 5207 are repeated.

In the case where the intensity after moving the focus lens 101a is decreased to a value smaller than the intensity before moving the focus lens 101a (YES in S208), the focus lens 101a is moved once to the infinity side by a minute distance (S209) and the process is ended. By repeating the aforementioned process, the position (focus position) of the focus lens 101a at which the intensity of the high-frequency component of the image data is a local maximum is determined.

### 2.2 Gain Adjustment

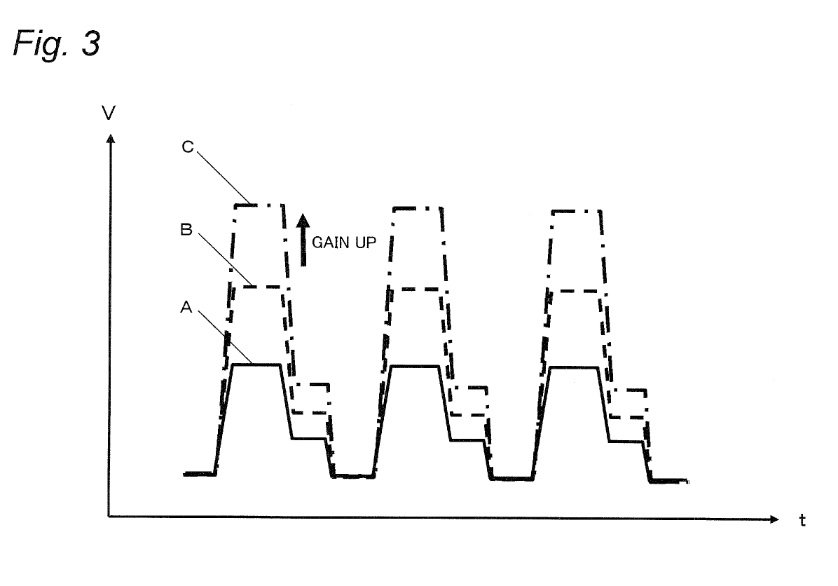

FIG. 3 is a diagram for explaining the concept of gain adjustment of the AGC amplifier 103b in the AFE 103. The abscissa axis represents the time (t), and the ordinate axis represents the voltage on. The solid line A indicates a waveform of the image signal input to the AGC amplifier 103b, and the dashed line B indicates a waveform of the image signal output from the AGC amplifier 103b. The CPU 104a sends a command for requesting the AFE 103 to set the gain level of the AGC amplifier 103b. In the case where the gain of the AGC amplifier 103b is set to be a value higher than the level indicated by the dashed line B, the level of the image signal output from the AGC amplifier 103b becomes higher as indicated by the waveform of the one-dot chain C.

2.3 Transition from Normal Operation Period to Focus Operation Period

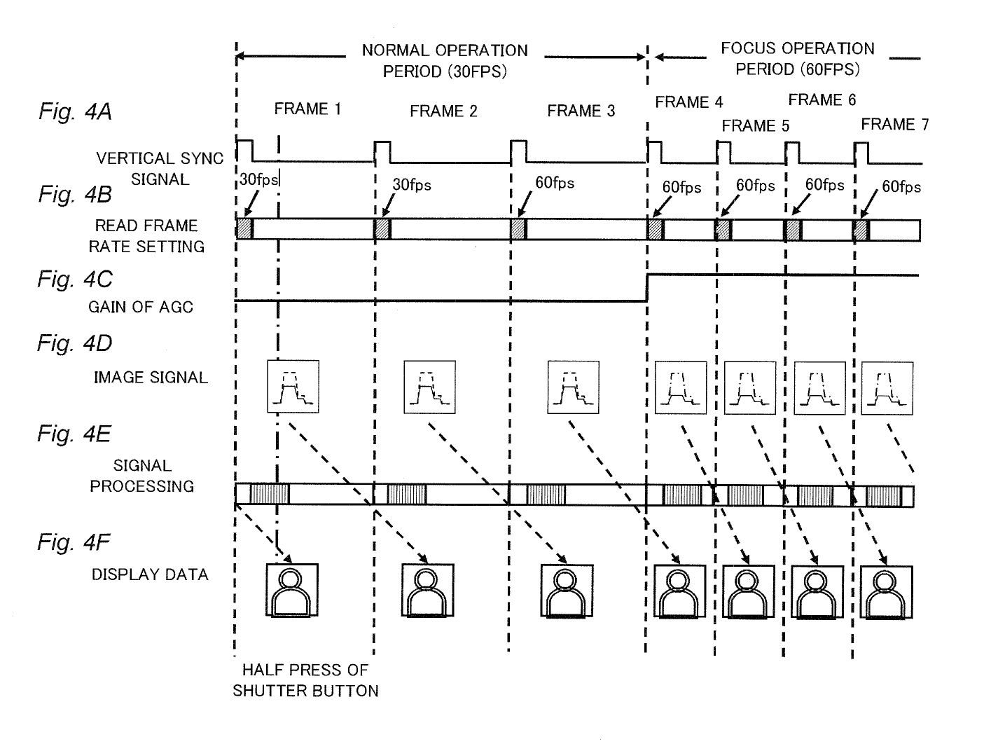

FIG. 4 is a timing chart showing the transition from the normal operation period to the focus operation period. The normal operation period is defined as a period during which the AFE 103 stores the image signal output from the CCD 102 for each frame as the image data in the SDRAM 105 and the signal processor 104b converts the image data stored in the SDRAM 105 into a display data suitable for display on the LCD 107 and outputs it to the LCD 107. During the normal operation period, the user can determine the composition by viewing the LCD 107. On the other hand, the focus operation period is defined as a period during which the focus operation described above is performed by the user with the shutter button 108 half-pressed as a trigger.

According to the following example, it is assumed that the shutter button 108 is half-pressed during the frame 1. The frames 1 to 3 are in the normal operation period, and the frames 4 to 7 are in the focus operation period. During the normal operation period, the read frame rate of the CCD 102 is set to 30 fps (frames per seconds), while during the focus operation period, the read frame rate is increased to 60 fps for high speed focus operation. The focus operation period is continued for frame 7 and subsequent frames (not shown) until the focus operation is completed.

Referring to FIG. 4B, the read frame rate is set during the vertical synchronizing period (hatched period in FIG. 4B), and the setting is effective from the next frame. For example, although the read frame rate is set to 30 fps for frames 1 and 2 it is set to 60 fps for frame 3 to secure the read frame rate of 60 fps for frame 4 and subsequent frames. For frame 4 and subsequent successive frames, the setting are set to 60 fps.

FIG. 4D shows the waveform of the image signal output from the CCD 102, that is waveforms of the input and output image signals of the AGC amplifier 103b in the AFE 103.

In frames 1 to 3 as the normal operation period, the image signal input to the AGC amplifier 103b is drawn with a solid line, and the signal output from the AGC amplifier 103b with a dashed line.

In frames 4 to 7 as the focus operation period, the read frame rate is set to 60 fps, and therefore the exposure time is limited to a maximum of 1/60 second. Especially, in the case where the subject is dark, a sufficient exposure amount may not be obtained due to the limited exposure time. Unless a sufficient exposure amount can be secured, the image signal is decreased in intensity, and the contrast value cannot be evaluated accurately, resulting in an unstable focus operation.

Therefore in switching the read frame rate, the CPU 104a determines whether an equal exposure amount is obtained or not (i.e. whether a sufficient exposure amount can be obtained or not) before and after switching the read frame rate. This determination can be made based on the read frame rates before and after the switching operation, the brightness of the image, the aperture value, the shutter speed, and so on. Upon determination that an equal exposure amount cannot be obtained, the CPU 104a instructs the AFE 103 to increase the gain of the AGC amplifier 103b to obtain an equal exposure amount. In the example of FIGS. 4A to 4F, in frames 4 to 7 as the focus operation period, the image signal output from the CCD 102, that is, the image signal input to the AGC amplifier 103b (indicated in a solid line) is smaller than that in frames 1 to 3 as normal operation period, and therefore, the exposure amount is determined to be insufficient. Thus, the gain of the AGC amplifier 103b is set to a higher value so that even when the image signal (solid line) input to the AGC amplifier 103b is decreased in level, an output signal at a level equivalent to the output image signal of the AGC amplifier 103b in frames 1 to 3 as the normal operation period can be secured (see FIG. 4C). FIG. 4D shows the output image signal of the AGC amplifier in the AFE 103 which is obtained as described above with a dashed-dotted line. On the other hand, upon determination that the same exposure amount can be obtained before and after switching the read frame rate, the CPU 104a does not change the gain of the AGC amplifier 103b.

FIG. 4E shows with vertical lines the signal processing timing at which the signal processor 104b converts the image data to the display data. Generally, the number of pixels of the CCD 102 is approximately ten million, while the number of pixels of the LCD 107 is not more than several hundred thousand. Therefore, in the case where the image of a subject is displayed on the LCD 107, the display data is generated by the YC separation process and compression process regardless of the normal operation period or the focus operation period.

The display data is generated in the frame following the frame in which the image data is stored in the SDRAM 105. Specifically, in frame 2, the image data stored in the SDRAM 105 in frame 1 is converted to the display data. In frame 3, the image data stored in the SDRAM 105 in frame 2 is converted to the display data. In frame 4, the image data stored in the SDRAM 105 in frame 3 is converted to the display data. Especially, in frame 5, the image data stored in frame 4 is converted to the display data based on the image signal obtained by increasing the gain of the AGC amplifier in the AFE 103.

As described above, in the digital camera according to the embodiment, the shortage of the exposure time due to an increased read frame rate is complemented by increasing the gain of the image signal. As a result, a high-speed, stable focus operation is made possible. Also, brightness of the display of the LCD 107 is not decreased when the focus operation period starts, so that the image displayed on the LCD 107 can be maintained in high quality.

2.4 Transition from Focus Operation Period to Normal Operation Period

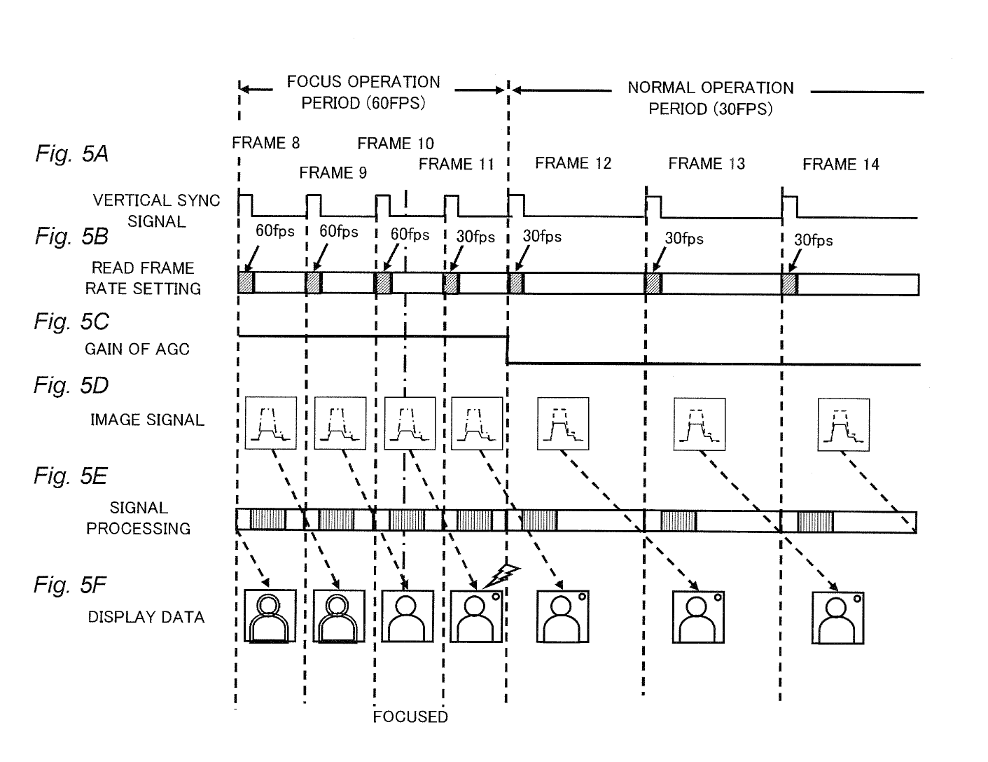

FIG. 5 is a timing chart showing the transition from the focus operation period to the normal operation period. In this example, it is assumed that the focus is confirmed in frame 10. In frame 11, the completion of the focus operation is notified to the user by displaying mark “◯” at the upper right part of the screen of the LCD 107 and a system sound (see FIG. 5F). The mark “◯” at the upper right part of the screen is kept displayed until the half-press operation of the shutter button 108 is canceled by the user or the half-press operation is transferred to the full-press operation to take a photo.

In FIG. 5, frames 8 to 11 are in the focus operation period and frames 12 to 14 are in the normal operation period. The read frame rate of the CCD 102 is 60 fps for the focus operation period, and it is decreased to 30 fps for the normal operation period.

The read frame rate is set during the vertical synchronizing period (hatched period in FIG. 5B) and effectuated from the next frame. The read frame rate is set to 60 fps for frames 8 to 10. The focus status can be confirmed in frame 10, and therefore the read frame rate is set to 30 fps in frame 11 to secure the read frame rate of 30 fps for frame 12 and all the subsequent frames. Thus, frame 12 and subsequent frames are set to 30 fps.

In FIG. 5D, like in FIG. 4D shows the waveform of the image signal output from the CCD 102, that is, waveforms of the image signal input to the AGC amplifier in the AFE 103 and the image signal output from the AGC amplifier in the AFE 103.

As shown in FIG. 5C, the gain of the AGC amplifier 103b in the AFE 103 is increased in frames 8 to 11 as the focus operation period like in frames 4 to 7 as shown in FIG. 4C. Similarly, in frames 12 to 14 as the normal operation period, like in frames 1 to 3 in FIG. 4C, the gain of the AGC amplifier 103b in the AFE 103 is decreased to a value lower than that for the focus operation period.

FIG. 5 shows with vertical lines the signal processing timing at which the image data is converted to the display data by the signal processor 104b. The display data is generated in the frame immediately following the frame in which the image data is stored in the SDRAM 105. In frame 12, for example, the image data stored in the SDRAM 105 in frame 11 is converted to the display data based on the image signal obtained by increasing the gain of the AGC amplifier 103b in the AFE 103.

In FIG. 5F, in frames 8 and 9 the contour of the person in the display data is indicated with double lines to notify that the focus operation is not completed. In frames 10 to 14, on the other hand, the contour of the person in the display data is indicated with solid line to notify that the focus operation is complete.

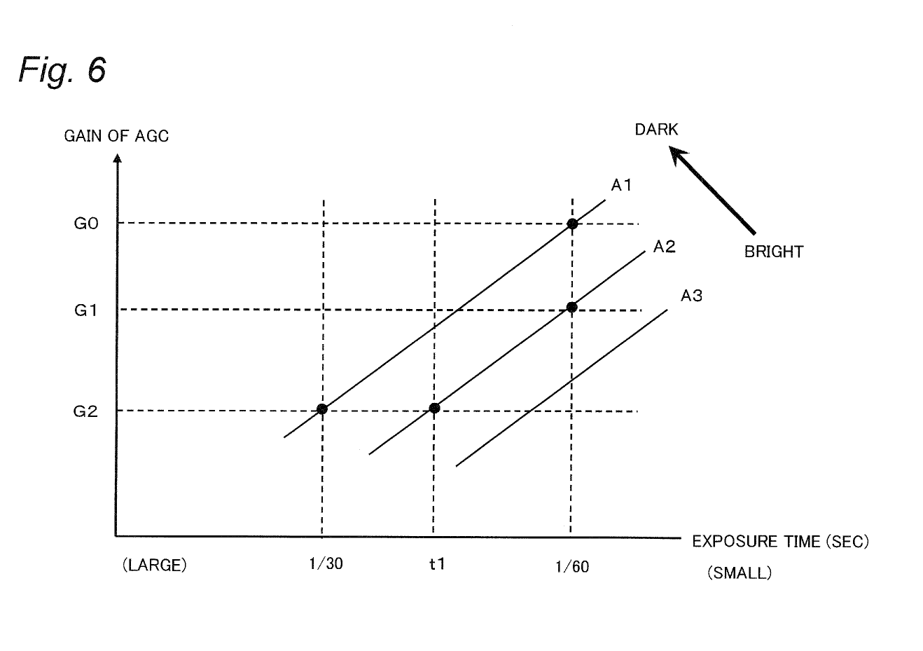

FIG. 6 is a diagram for explaining the operation of switching the gain of the AGC amplifier 103b. In FIG. 6, the ordinate axis represents the gain of the AGC amplifier 103b, and the abscissa axis represents the exposure time. In FIG. 6, the exposure time is decreased as it goes rightward along the abscissa. FIG. 6 assumes that the aperture and the brightness of the subject are constant. Also, in FIG. 6, the combination of the gain and the exposure time gives the same exposure amount on the diagonal lines, that is, the lines A1, A2 and A3. For example, it is assumed that the read frame rate is switched from 30 fps to 60 fps with the exposure time set to 1/30 second and the gain of the AGC amplifier 103b to the gain G2. In this case, since the read frame rate is switched to 60 fps, the exposure time is set to 1/60 second. The gain of the AGC amplifier 103b is determined along the line A1 and set at the gain G0. As a result, the same exposure amount is obtained before and after switching the read frame rate. In similar fashion, it is considered that the read frame rate is switched from 30 fps to 60 fps with the exposure time of t1 seconds (> 1/60 second) and the gain of the AGC amplifier 103b set to the gain G2. In this case, the exposure time (t1 seconds) before switching the read frame rate is larger than 1/60 second. After switching the read frame rate, therefore, the exposure time is set to 1/60 second and the gain of the AGC amplifier 103b is determined along the line A2 and set to the value G1. In the case where the exposure time for the operation period with the read frame rate of 30 fps is smaller than 1/60 second, the exposure time is not limited even when switching the read frame rate from 30 fps to 60 fps, and therefore the gain of the AGC amplifier 103b is not changed. Specifically, according to the embodiment, the gain is controlled in such a manner that the equivalent exposure time is obtained when switching the read frame rate from 30 fps to 60 fps with the exposure time in the range of 1/30 to 1/60 seconds.

### 3. Summarization

As described above, with the digital camera according to the embodiment, the gain of the AGC amplifier 103b for amplifying the image signal obtained from the CCD 102 is increased during the focus operation period. This arrangement compensates the shortage of the exposure time due to the increased read frame rate for the focus operation period. Therefore, a high-speed, stable focus operation can be performed very advantageously. Also, the brightness of the image displayed on the LCD 107 is not decreased when the focus operation period starts, so that the quality of the image displayed on the LCD 107 can be maintained.

An alternative method of compensating the shortage of the exposure time during the focus operation period would be considered in which the image signal level of a certain pixel is increased by adding the pixel values of the neighboring pixels. However, in this method, the high-frequency component of the image data is lost by the addition of pixel values, resulting in a lower accuracy in the image data evaluation. In contrast, no such problem occurs in the embodiment in which the image signal of a high level is obtained by increasing the gain of the AGC amplifier 103b.

According to the embodiment, the gain of the AGC amplifier 103b is adjusted to obtain the equivalent exposure amount between before and after switching the read frame rate. It should be noted that the term “equivalent” does not mean that the exposure amounts between before and after switching the read frame rate are completely the same but means “substantially equivalent”. For example, as long as the image signal after switching the read frame rate does not become extremely small due to increase of the read frame rate so that the contrast value can be estimated accurately and the focus operation can be performed rapidly, there may be a predetermined range of difference in exposure amount between before and after switching the read frame rate. That is, the gain of the AGC amplifier 103b may be adjusted so that the change in the exposure amount is within a predetermined value before and after switching the read frame rate.

### 4. Miscellaneous

### 4.1 Read Frame Rate

In the digital camera according to the embodiment, the same read frame rate is set between the frame immediately before the focus operation period and the frames for the normal operation period. Nevertheless, the read frame rate for the frame immediately before the focus operation period may alternatively be set higher than that for the normal operation period and lower than that for the focus operation period. By doing so, the image of the subject can be continuously displayed more smoothly without a large change in the read frame rate during the transition from the normal operation period to the focus operation period.

### 4.2 Brightness of Subject

With the digital camera according to the embodiment, the gain of the AGC amplifier 103b is controlled in such a manner that the AGC amplifier 103b can output the image signal having the intensity in the focus operation period equivalent to that in the normal operation period. However, the control method of the gain is not limited to such a method.

The brightness of the subject may be detected by the exposure meter 112 or based on the brightness component contained in the image data, and the gain of the AGC amplifier 103b may be controlled further upward to produce a larger output image signal of the AGC amplifier 103b than that for the normal operation period in the case where the detected brightness of the subject is lower than a predetermined brightness value. As a result, the greater shortage of the exposure time caused by increasing the read frame rate for an originally dark subject can be compensated by further increasing the gain of the image signal. Thus, the high-speed focus operation can be performed without any instability.

In the case where the subject is not so dark, the gain of the AGC amplifier 103b may be increased as high as possible. In this way, the problem of a decreased S/N which might be caused by increasing the gain more than necessary can be avoided. Further, also during the focus operation, the brightness of the subject may be detected by the exposure meter 112 or based on the brightness component contained in the image data, and the gain of the AGC amplifier 103b may be dynamically controlled according to the detected brightness of the subject.

### 4.3 Display Frame Rate

The display frame rate of the LCD 107 may be the same as the read frame rate of the CCD 102. As an alternative, the same display frame rate may be maintained between the normal operation period and the focus operation period without regard to the change in the read frame rate of the CCD 102. In the former case, the image of the subject can be continuously displayed more smoothly during the focus operation period. In the latter case, on the other hand, the display frame rate does not change during the focus operation period, so that the sense of discomfort of the user which might be caused by the change in the display frame rate can be avoided.

### 4.4 Type of Digital Camera

An embodiment is described above with reference to an example of the digital camera having an optical system 101 therein. However, the aforementioned concept of the embodiment in which the gain of the AGC amplifier is switched appropriately in accordance with the read frame rate is of course applicable with equal effect to a single-lens digital camera which an interchangeable lens including an optical system is mountable.

### INDUSTRIAL APPLICABILITY

According to the embodiment, the shortage of the exposure time due to an increased read frame rate is offset by increasing the gain of the image signal. Therefore, this embodiment is usefully applicable to imaging devices which perform the focus operation while allowing the user to view the image on the display unit, such as a digital camera, a digital video camera, and a mobile phone.

What is claimed is:

1. An imaging apparatus comprising:
an imaging unit operable to output an image signal of a subject;
an amplifier unit operable to amplify the image signal output by the imaging unit;
a gain adjusting unit operable to adjust a gain of the amplifier unit; and
a frame rate adjusting unit operable to set a read frame rate of the imaging unit for a normal operation period to a first frame rate, and set the read frame rate for a focus operation period to a second frame rate which is larger than the first frame rate,
wherein when the frame rate adjusting unit changes the read frame rate of the imaging unit from the first frame rate to the second frame rate, the gain adjusting unit adjusts the gain of the amplifier unit so that a substantially equivalent exposure amount is maintained before and after the change in the read frame rate.

2. The imaging apparatus according to claim 1, wherein the gain adjusting unit adjusts the gain of the amplifier unit in accordance with a brightness of the subject.

3. The imaging apparatus according to claim 1, wherein in the focus operation, the focus state is detected using a contrast detection method.

4. The imaging apparatus according to claim 1, wherein the first frame rate is 30 fps and the second frame rate is 60 fps.
